(19) United States
(12) Patent Application Publication
(10) Pub. No.: US 2006/0008767 A1
(43) Pub. Date: Jan. 12, 2006

(54) Oral care devices

(75) Inventor: Scott Donald Whalen, Cincinnati, OH (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/099,737

(22) Filed: Apr. 6, 2005

Related U.S. Application Data
(60) Provisional application No. 60/586,560, filed on Jul. 9, 2004.

(51) Int. Cl. A61C 1/07

(52) U.S. Cl. 433/119

(57) ABSTRACT

An oral care device for use in an oral cavity is provided. The oral care device comprises a handle having proximal and distal ends and an acoustic emitter disposed at the distal end of the handle. An emitting surface is acoustically coupled to the acoustic emitter. The emitting surface is sized for insertion to the oral cavity.

### CROSS REFERENCE TO RELATED APPLICATION

This application claims the benefit of U.S. Provisional Application No. 60/586,560, filed Jul. 9, 2004, the substance of which is incorporated herein by reference.

### FIELD OF THE INVENTION

The present invention relates to the field of oral care devices, and, more particularly, to oral care devices that emit pressure pulses or acoustic energy.

### BACKGROUND OF THE INVENTION

There is a continuing desire to improve the effectiveness of delivery of oral care actives to the teeth and gums. There is further a continuing desire to decrease the amount of time required to deliver actives to the teeth and/or soft tissue of the oral cavity.

### SUMMARY OF THE INVENTION

An oral care device for use in an oral cavity is provided. The oral care device comprises a handle having proximal and distal ends and an acoustic emitter disposed at the distal end of the handle. An emitting surface is acoustically coupled to the acoustic emitter. The emitting surface is sized for insertion to the oral cavity.

### BRIEF DESCRIPTION OF THE DRAWINGS

It is believed that the present invention may be better understood from the following description of embodiments, taken in conjunction with the accompanying drawings, in which like reference numerals identify identical elements and wherein:

FIG. 1 is a perspective view of an oral care device made in accordance with the present invention;

FIG. 2 is a top plan view of the oral care device of FIG. 1 shown disposed against a strip of material having an oral care substance disposed thereon; and

FIG. 3 is a perspective view of another oral care device made in accordance with the present invention.

### DETAILED DESCRIPTION OF THE EMBODIMENTS

All printed publications, patents, and patent applications referenced herein are incorporated herein by reference. The present invention is directed to oral care devices that are sized for use in an oral cavity and which, in one embodiment, are sized for placement against a plurality of teeth. The oral care devices incorporate an acoustic emitter that generates pressure pulses in response to an applied voltage. As used herein, the term “acoustic” is intended to relate to audible, sonic, or ultrasonic waves or vibrations. The devices of the present invention are used in combination with an oral care substance containing an oral care active. The oral care active can be any active that can provide a benefit to the teeth or soft tissue. The oral care substance may be applied to the device and then to the teeth or soft tissue or the oral care substance may be first applied to the teeth or soft tissue and then the device is applied to the oral care substance. While not intending to be bound by any theory, it is believed that the acoustic energy or pressure pulses can renew the concentration of the of the oral care active at the boundary between the oral care substance and the tooth or tissue surface, which can ensure the maximum concentration gradient to drive diffusion of the oral care active into the tooth surface and/or contact with such surface

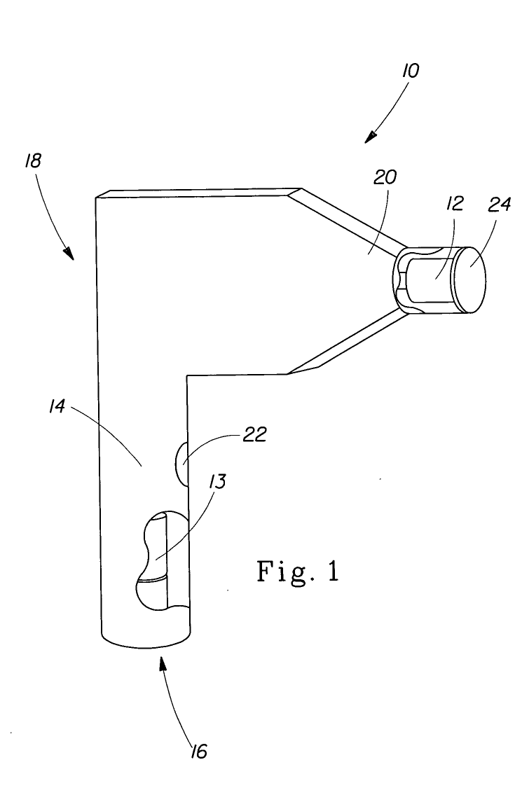

Referring to FIG. 1, an oral care device 10 made in accordance with the present will now be described. The oral care device 10 comprises an acoustic emitter 12 and a voltage source in electrical communication with the acoustic emitter 12. The voltage source can supply either an alternating electrical current or direct current to the acoustic emitter 12, as desired. The oral care device 10 can further include a voltage source in the form of one or more batteries 13 or can be connected to an external power source (not shown) such as an AC electrical outlet. The oral care device 10 has a handle 14 having a proximal end 16 and the acoustic emitter 12 is disposed near or at a distal end 18 of the handle 14 opposite the proximal end 16. The acoustic emitter 12 can be provided in a housing 20 at the distal end 18. A switch 22 can be provided on the handle for actuating the oral care device 10. The acoustic emitter 12 can be provided in a variety of forms. For example, the acoustic emitter 12 may provided as a piezoelectric transducer or as a magnetorestrictive transducer. The piezoelectric transducer can include a piezoelectric polymer, such as polyvinylidene fluoride (PVDF) polymers or copolymers, or a piezoelectric ceramic for producing output acoustical energy. The piezoelectric polymer can be provided in the form of a film. In order to reduce the required power input to the transducer, the transducer can be used to excite another mechanical structure, such as even a second piezoelectric film, at a particular natural frequency that is compatible with the oral care substance.

The acoustic emitter can operate at a frequency greater than about 20 kHz, or greater than about 50 kHz, or greater than about 100 kHz, or greater than about 250 kHz, or greater than about 500 kHz, or greater than about 1000 kHz and/or less than about 5 MHz, or less than about 2 Mhz, or less than about 1 Mhz, or less than about 500 kHz. Where the oral care active is a tooth whitening agent, such as hydrogen peroxide, a preferred frequency range can be about 20 KHz to about 500 kHz.

The housing 20 has an emitting surface 24 sized to cover a portion of the front surface of one or more teeth. The emitting surface 24 may form part of the acoustic emitter 12 or it may be a separate mechanical structure that can be excited by the acoustic emitter 12, as previously described. In other words, the emitting surface 24 may be acoustically coupled to the acoustic emitter 12 such that a vibration of the acoustic emitter induces a vibration in the emitting surface 24. In addition, the emitting surface 24 may be mechanically coupled as well as acoustically coupled to the acoustic emitter 12, such as in the case when it forms a part of a transducer. The emitting surface 24 may have a surface area between about 0.5 cm2 and about 7 cm2 or between about 1 cm2 and about 5 cm2. In one embodiment, the emitting surface is provided as a smooth surface devoid of protruding structures. The oral care device 10 can also be provide in the form of an electric toothbrush with bristles or tufts of bristles surrounding, or partially surrounding, the emitting surface 24. During use, the emitting surface 24 is placed in contact with the oral care composition for a period of time greater than about 1 minute, or greater than about 2 minutes, or greater than about 3 minutes, or greater than about 4 minutes, or greater than about 5 minutes, or greater than about 10 minutes and/or less than about 30 minutes, or less then about 15 minutes, or less than about 10 minutes, or less than about 5 minutes. In one embodiment, the emitting surface has an acoustic intensity output that is less than about 2 W/cm2, or less than about 1 W/cm2, or less than about 0.5 W/cm2 and/or greater than 0.1 W/cm2 or greater than about 0.25 W/cm2 or greater than about 0.5 W/cm2.

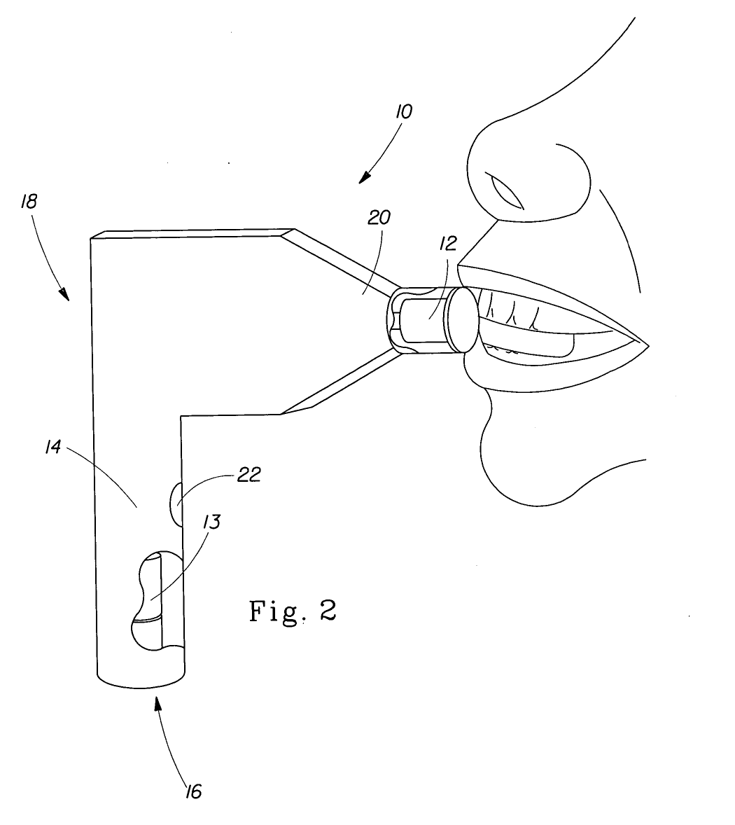

The oral care device 10 may be moved about the facial tooth surfaces of the maxillary or mandibular arches during use. While the emitting surface 24 has been described as contacting the oral care substance, it is contemplated that the emitting surface 24 may contact other surfaces that are interposed between the oral care substance and the emitting surface 24. For example, the emitting surface 24 can be placed against a surface of strip of material that has the oral care substance applied to an opposing side of the strip of material, as shown in FIG. 2, so that the acoustic energy of the emitting surface 24 is transmitted through the strip of material to the oral care substance. Examples of strips of material and oral care substances which may be suitable for use are set forth in U.S. Pat. Nos. 5,891,453 and 6,136,297.

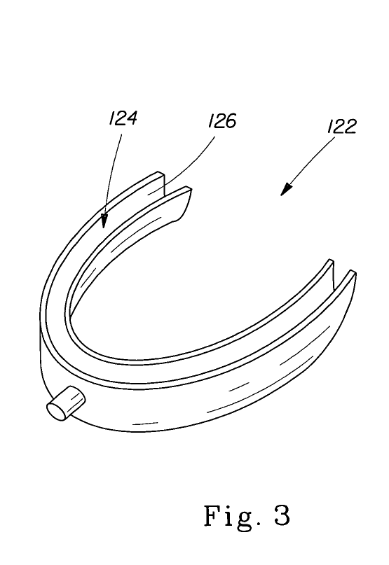

Referring to FIG. 3, another oral care device of the present invention is illustrated in the form of an arched tray 122 and an acoustic emitter 12. The tray is sized to cover a plurality of teeth of either the maxillary and/or mandibular arches. The tray 122 has a first trough or channel 124 into which at least a portion of the maxillary arch may be inserted. A second channel (not shown) can be provided opposite the first channel 124 for receiving at least some of the teeth of the mandibular arch. The first channel 124 has an interior surface 126 which is disposed adjacent the facial tooth surfaces of the maxillary arch during use. The tray 122 may be solid or hollow, or a combination thereof. If the tray 122 is hollow, it may be filled with a liquid or gas to assist with transmitting the acoustic energy of the acoustic emitter 12 throughout the tray 122 to the interior surface 126. The interior surface 126 of the tray 122 that is disposed adjacent the facial tooth surfaces during use may be thinner or provided as a distinct material from the remainder of the tray 122 so that the interior surface 126 can act as a diaphragm for transmitting the acoustic energy of the acoustic emitter 12 to an oral care composition disposed within the tray 122. The acoustic emitter 12 can be attached to the tray 122 so that is either mechanically or acoustically coupled to the interior surface 126 which acts as an emitting surface for the acoustic energy generated by the acoustic emitter 12. A plurality of acoustic emitters 12 can be attached to the tray 122 if desired.

Examples of oral care substances suitable for use with the present invention will now be described. The oral care substances can be provided as solutions, gels, pastes, solid or semi-solid substances. Oral care actives which may be used with the present invention include, but are not limited to, tooth whitening or bleaching agents, anti-calculus and anti-plaque agents, anti-caries agents, anti-gingivitis agents, anti-microbial agents, anti-inflammatory agents, phosphates, fluorides, nutrients, enzymes, anti-oxidants, and H-2 antagonists. Suitable tooth whitening actives include peroxides, metal chlorites, perborates, percarbonates, peroxyacids and combinations thereof. Suitable peroxides include hydrogen peroxide, calcium peroxide, carbamide peroxide and combinations thereof. Suitable metal chlorites include calcium chlorite, barium chlorite, magnesium chlorite, lithium chlorite, sodium chlorite, and potassium chlorite. The concentration of the oral care active can be provided in an amount greater than about 0.01%, or greater than about 0.1%, or greater than about 0.5%, or greater than about 1%, or greater than about 5% and/or less than about 40%, or less than about 20%, or less than about 15%, or less than about 10% by weight of the oral care substance. In one embodiment of a tooth whitening substance, a tooth whitening active can be provided in an amount between about 3% and about 20% by weight of the tooth whitening substance. The oral care substance can include other components such as thickening agents, surfactants, water, solvents, pH adjusting agents, humectants, stabilizers or chelating agents, preservatives, flavorants, sweetening agents, and combinations thereof. In one embodiment, a suitable matrix or carrier for an oral care substance comprises a water-in-oil emulsion, such as the mixture of aqueous hydrogen peroxide, mineral oil, and a surfactant. Other oral care substances that may be suitable for use with the present invention are described in U.S. Pat. Nos. 6,488,914; 5,851,514; 4,980,152; 3,657,413; 4,983,380; 5,084,268; 5,171,564; 5,376,006; 5,645,428; 5,713,738; RE 34,196; 5,122,365; 6,558,654; 6,555,020; 6,536,628; 6,533,582; 6,521,215; 6,514,543; 6,479,037; 6,447,757; 5,891,453; 6,555,020; 6,136,297; 6,682,722; 6,589,512; 5,437856; 5,431,903; 5,320,831; 5,320,830; 5,281,410; 5,213,790; 5,145,666; 6,096,328; 5,281,412; 5,281,411; 5,004,597; and 6,419,905 and Application Nos. WO 03/007680, and 10/154,020.

The present invention has been described with reference to multiple embodiments. Obviously, modifications and alterations will occur to others upon a reading and understanding of this specification. For example, while the present invention has been described with respect to devices that are sized to cover the facial tooth surfaces, it is contemplated that the present invention can also be used in combination with soft tissue of the oral cavity such as gingival tissue, in which instance the tray 122 might be sized to overlap with this tissue. As such, the present invention is intended to include all such modifications and alterations or the equivalents thereof.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An oral care device for use in an oral cavity, comprising:
a handle having proximal and distal ends;
an acoustic emitter disposed at said distal end of said handle; and
an emitting surface acoustically coupled to said acoustic emitter, wherein said emitting surface is sized for insertion to said oral cavity.

2. The oral care device of claim 1, wherein said emitting surface is part of said acoustic emitter.

3. The oral care device of claim 1, wherein said emitting surface vibrates at a frequency between about 20 kHz and about 5 MHz.

4. A method of delivering an oral care active to one or more teeth, comprising:
applying an oral care substance comprising an oral care active to one or more teeth;
applying an oral care device having an emitting surface to said one or more teeth; wherein said emitting surface vibrates at a frequency between about 20 kHz and about 5 MHz.

5. The method of claim 4, wherein said oral care active is a tooth whitening active.

6. The method of claim 4, wherein said oral care active is a peroxide.

7. An oral care device, comprising:
a tray having an interior surface, wherein said tray is sized for insertion into an oral cavity;
an acoustic emitter attached to said tray and acoustically coupled to said interior surface of said tray.
